(19) United States
(12) Patent Application Publication
(10) Pub. No.: US 2021/0241972 A1
(43) Pub. Date: Aug. 5, 2021

(54) CONFIGURATIONS FOR SHIELDING ELECTRIC FIELD EMISSIONS FROM A TRANSMITTER COIL

(71) Applicant: Intuitive Surgical Operations, Inc., Sunnyvale, CA (US)

(72) Inventors: Marc E. Tognaccini, Morgan Hill, CA (US); Douglas C. Smith, Boulder City, NV (US)

(73) Assignee: Intuitive Surgical Operations, Inc.

(21) Appl. No.: 17/162,978

(22) Filed: Jan. 29, 2021

Related U.S. Application Data
(60) Provisional application No. 62/967,937, filed on Jan. 30, 2020.

(51) Int. Cl. H01F 38/14; H01F 27/36

(52) U.S. Cl. CPC H01F 38/14; H01F 27/36

(57) ABSTRACT

An exemplary system includes a transmitter coil configured to wirelessly transmit a signal to a receiver coil and an electrically conductive shield between the transmitter coil and the receiver coil and connected to an electrical ground. The electrically conductive shield is positioned to shunt electric field energy generated by the transmitter coil to the electrical ground and allow magnetic field energy to pass from the transmitter coil to the receiver coil.

### RELATED APPLICATIONS

The present application also claims priority under 35 U.S.C. § 119(e) to U.S. Provisional Patent Application No. 62/967,937, filed Jan. 30, 2020, which application is incorporated herein by reference in its entirety.

### BACKGROUND INFORMATION

An exemplary first device includes a wireless connector at a distal end of a relatively long cable. The wireless connector is shaped to plug into a receptacle of a second device without making electrical contact with the controller. In this configuration, a transmitter coil in the second device can inductively transmit power to a receiver coil in the wireless connector, thereby powering the first device.

Unfortunately, wireless power transmission circuits are inherently electrically noisy due to an unwanted common-mode coil drive signal component. This electric noise may be transmitted to the receiving coil via electric field coupling and, due to the relatively long cable, result in undesirable levels of radiated electromagnetic interference. For example, this interference is especially problematic during electronic video signal transmission because the interference degrades the quality of the video signal data being transmitted and the resulting displayed image. During surgery, however, endoscopic images should be as clear as possible to provide a surgeon with the best possible images of a surgical site.

### SUMMARY

An exemplary system includes a transmitter coil configured to wirelessly transmit a signal to a receiver coil, and an electrically conductive shield between the transmitter coil and the receiver coil and connected to an electrical ground. The electrically conductive shield is positioned to shunt electric field energy generated by the transmitter coil to the electrical ground and allow magnetic field energy to pass from the transmitter coil to the receiver coil.

An exemplary assembly includes a printed circuit board having an electrical ground, a transmitter coil on the printed circuit board and connected to the electrical ground, and an electrically conductive shield that physically covers at least a first portion of a top surface of the transmitter coil. The electrically conductive shield is connected to the electrical ground, and a receptacle is positioned to receive a contactless connector of an instrument. The printed circuit board, the transmitter coil, and the electrically conductive shield are behind a wall of the receptacle such that, while the contactless connector is positioned in the receptacle, the transmitter coil is aligned with a receiver coil in the contactless connector and the electrically conductive shield is between the transmitter coil and the receiver coil.

An exemplary system includes a controller and an instrument. The controller includes a printed circuit board having an electrical ground, a transmitter coil on the printed circuit board and connected to the electrical ground, an electrically conductive shield that physically covers at least a first portion of a top surface of the transmitter coil, and a receptacle. The electrically conductive shield is connected to the electrical ground. The instrument includes a contactless connector shaped to be inserted into the receptacle and a receiver coil in the contactless connector. The transmitter coil and the electrically conductive shield are behind a wall of the receptacle such that, while the contactless connector is in the receptacle, the transmitter coil is aligned with the receiver coil and the electrically conductive shield is between the transmitter coil and the receiver coil.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 depicts a configuration in which a transmitter coil is wirelessly coupled to a receiver coil.

FIGS. 2A-2B show exemplary implementations of the configuration of FIG. 1.

FIG. 3 shows a top view of a printed circuit board included in a transmitting device.

FIGS. 4A-4B show different implementations of an electrically conductive shield covering a transmitter coil.

FIGS. 5A-5B show an exemplary implementation of a transmitting device and a receiving device.

### DETAILED DESCRIPTION

Configurations for shielding electric field emissions from a transmitter coil are described herein. To illustrate, an exemplary system includes a transmitter coil configured to wirelessly transmit a magnetic field signal to a receiver coil and an electrically conductive shield between the transmitter coil and the receiver coil and connected to an electrical ground. The electrically conductive shield is positioned to shunt electric field energy generated by the transmitter coil to the electrical ground and allow magnetic field energy to pass from the transmitter coil to the receiver coil. This, in turn, reduces a magnitude of radiated electromagnetic interference that may be produced by one or more components (e.g., a cable) of a device of which the receiver coil is a part. This can, in some situations, facilitate compliance with radiated emissions limits for medical devices as mandated by regulatory agencies (e.g., the United States Food and Drug Administration).

The shielding configurations described herein differ from other conventional field-blocking configurations in a number of ways. For example, in a conventional Faraday shield of a transformer, the magnetic and electric energy fields are both blocked by the shield. In contrast, the conductive shield described herein allows magnetic field energy to pass through the shield.

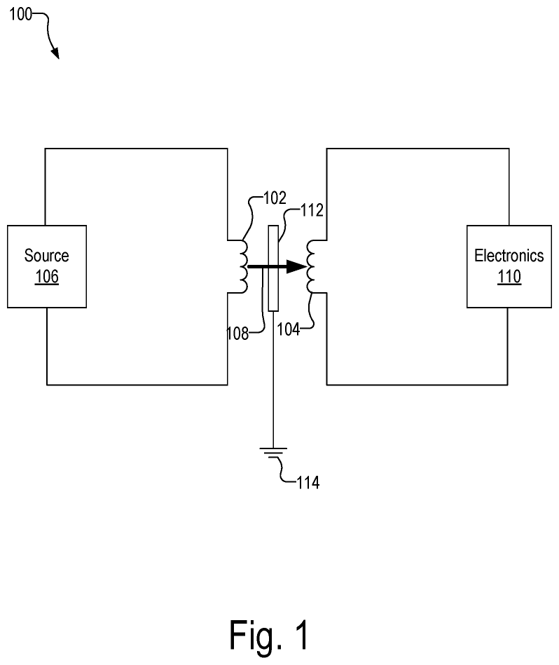

FIG. 1 depicts a configuration 100 in which a transmitter coil 102 is wirelessly (e.g., inductively) coupled to a receiver coil 104. In some examples, transmitter coil 102 is a part of a wireless transmitter circuit (e.g., a video data transmitter circuit, and more specifically a surgical video data transmitter circuit), and receiver coil 104 is a part of a wireless receiver circuit (e.g., a video data receiver circuit, and more specifically a surgical video data receiver circuit). Transmitter coil 102 and receiver coil 104 may be made out of any suitable material and may include any suitable number of wire windings. To be wirelessly coupled, transmitter coil 102 and receiver coil 104 are aligned and positioned in relatively close proximity one with another, as described herein.

Transmitter coil 102 is electrically connected to a source 106. Source 106 is configured to generate and provide a signal to transmitter coil 102. In some examples, source 106 is a power source (e.g., a current source or a voltage source). In these examples, the signal generated by source 106 includes power that is to be wirelessly transmitted to receiver coil 104. Source 106 may alternatively be any other type of signal source, and the signal generated by source 106 may alternatively be any other type of signal (e.g., a data signal, such as a video data signal, and more specifically a surgical video data signal).

Transmitter coil 102 is configured to wirelessly transmit the signal generated by source 106 to receiver coil 104. This wireless transmission is represented in FIG. 1 by an arrow 108 and may be performed using any suitable wireless signal transmission protocol. Arrow 108 represents the magnetic field energy delivered through shield 112 to receiver coil 104. In contrast, in a conventional Faraday shield, the magnetic field energy is not passed through shield 112. Rather, a conventional Faraday shield is highly conductive and blocks both the electric field energy and the magnetic field energy.

Receiver coil 104 is electrically connected to electronics 110. Electronics 110 include any suitable combination of electrical components. Electronics 110 are configured to use the signal wirelessly transmitted by transmitter coil 102 to receiver coil 104. For example, power included in the signal may be used to provide operating power to electronics 110.

An electrically conductive shield 112 (“shield 112”) is between transmitter coil 102 and receiver coil 104. In other words, shield 112 is in a wireless signal path between transmitter coil 102 and receiver coil 104. Shield 112 may be made out of any suitable electrically conductive material that has a an electrical conductivity rating that is less than a predetermined threshold that allows shield 112 to block electric field energy without blocking magnetic field energy. For example, shield 112 may be made out of an electrically conductive tape (e.g., copper tape), an electrostatic discharge (ESD) silver bag, or an electrically conductive plate. In some examples, shield 112 is rigid. Alternatively, shield 112 may be flexible. Exemplary implementations of shield 112 are described herein.

Shield 112 is connected to an electrical ground 114 (“ground 114”). In this configuration, shield 112 is positioned to shunt electric field energy generated by transmitter coil 102 to ground 114 and allow magnetic field energy to pass from transmitter coil 102 to receiver coil 104. As described herein, this allows a desired signal to be wirelessly transmitted from transmitter coil 102 to receiver coil 104 without inducing an excessive amount of radiated electromagnetic interference by electronics 110 and/or other components on the receiver side.

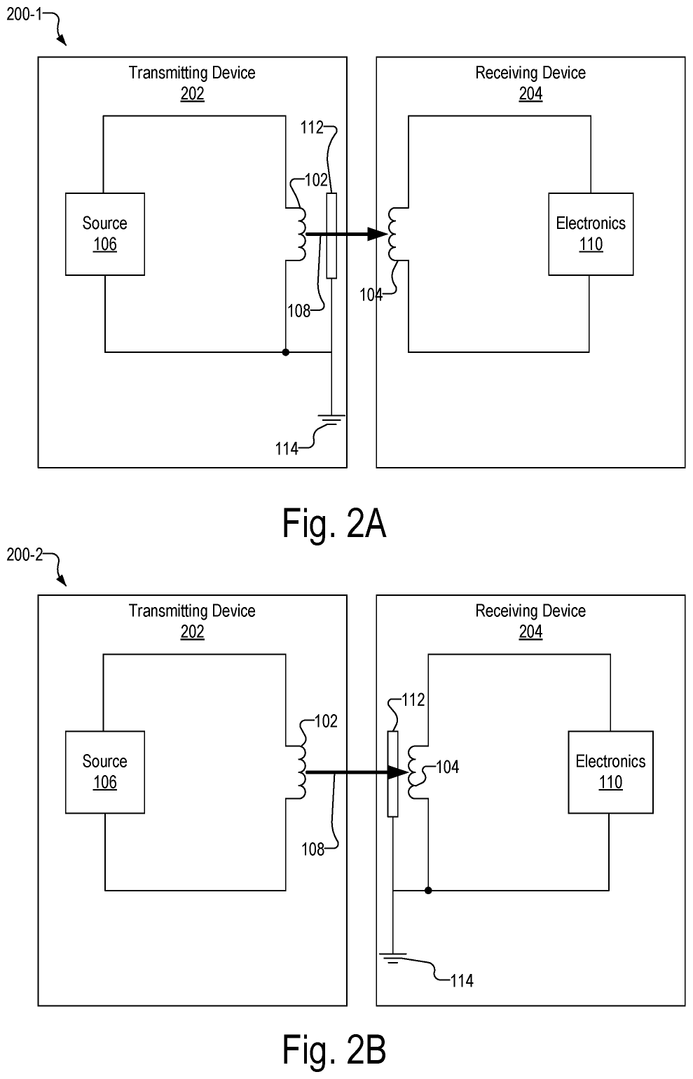

FIGS. 2A-2B show exemplary implementations 200-1 and 200-2 of configuration 100. In both implementations 200, a transmitting device 202 includes transmitter coil 102 and source 106, and a receiving device 204 includes receiving coil 104 and electronics 110. Transmitting device 202 and receiving device 204 may each be implemented by any suitable device. For example, transmitting device 202 may be implemented by a controller, and receiving device 204 may be implemented by an instrument configured to be powered and/or controlled by the controller. To illustrate, the instrument may be a surgical instrument (e.g., an imaging device such as an endoscope), and the controller may be an electronic circuit included in a computer-assisted surgical system and configured to provide power to and control an operation of the surgical instrument.

In implementation 200-1, shield 112 and ground 114 are in transmitting device 202. For example, transmitter coil 102 and source 106 may be on a printed circuit board (PCB) in transmitting device 202. The PCB may have a ground plane or any other suitable electrical ground that implements ground 114. As shown, in implementation 200-1, transmitter coil 102, source 106, and shield 112 are all connected to the same ground 114.

In alternative implementation 200-2, shield 112 and ground 114 are in receiving device 204. For example, receiver coil 104 and electronics 110 may be on a PCB in receiving device 202. The PCB may have a ground plane or any other suitable electrical ground that implements ground 114. As shown in implementation 200-2, receiver coil 104, electronics 110, and shield 112 are all connected to the same ground 114.

While shield 112 may be in either transmitting device 202 or receiving device 204, as illustrated in FIGS. 2A-2B, shield 112 is in transmitting device 202 in the examples that follow.

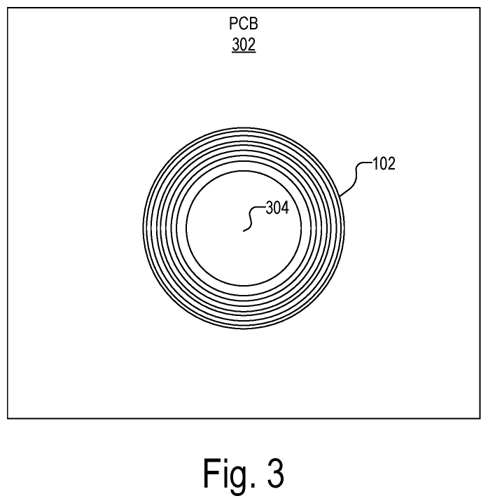

FIG. 3 shows a top view of a PCB 302 in transmitting device 202. As shown, transmitter coil 102 is on PCB 302. As shown, transmitter coil 102 is implemented by a plurality of conductive wires that radially surround a center void 304. Because FIG. 3 is a top view, the portion of transmitter coil 102 shown in FIG. 3 is referred to herein as a “top surface” of transmitter coil 102. In FIG. 3, shield 112 has not yet been positioned over the top surface of transmitter coil 102.

PCB 302 includes ground 114 (not shown). Ground 114 may be implemented by a ground layer, one or more ground traces, and/or any other suitable electrical ground.

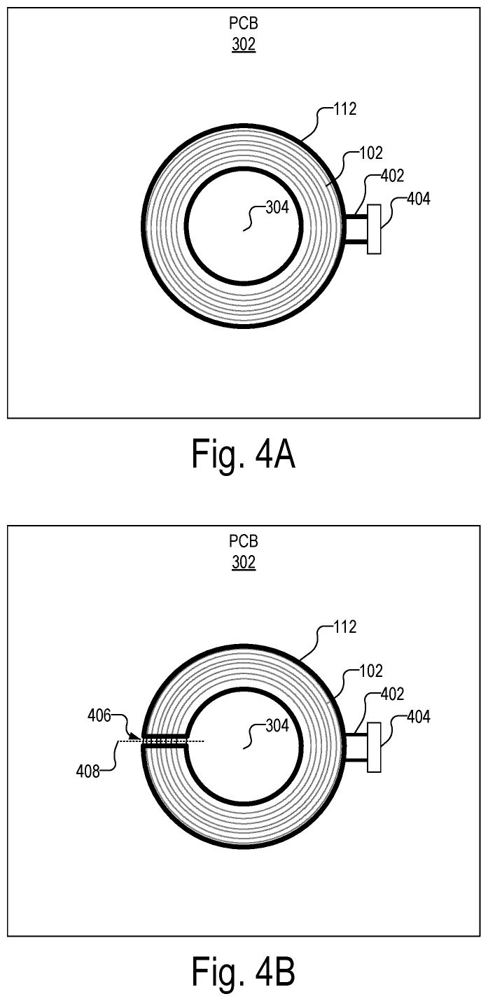

FIGS. 4A-4B show different implementations of shield 112 covering transmitter coil 102 on PCB 302. In both FIGS. 4A-4B, shield 112 is shown outlined with relatively thick lines and is shown partially transparent so as to show the conductive wires of transmitter coil 102 that are underneath shield 112. Shield 112 may be in physical contact with the top surface of transmitter coil 102. Alternatively, a gap may separate shield 112 from the top surface of transmitter coil 102.

In the implementation of FIG. 4A, shield 112 covers the entire top surface of transmitter coil 102. Shield 112 does not cover center void 304. In alternative configurations, shield 112 may at least partially cover center void 304 in addition to covering the entire top surface of transmitter coil 102.

An electrically conductive connector 402 (“connector 402”) conductively connects shield 112 to ground 114 at a contact point 404 on PCB 302. Connector 402 may be implemented by electrically conductive tape, a wire, a resistor, and/or any other suitable connector that provides an electrical connection between shield 112 and ground 114 at contact point 404. In alternative configurations, multiple connectors 402 may be used to conductively connect shield 112 to ground 114 at multiple contact points 404 on PCB 302. In some configurations, one or more non-electrically conductive connectors may be used to structurally connect shield 112 to PCB 302 at one or more other contact points.

In the implementation of FIG. 4B, shield 112 includes a slit 406 that exposes a portion of the top surface of transmitter coil 102. Slit 406 is dimensioned to prevent eddy currents from being inducted from transmitter coil 102 into shield 112 and may be of any suitable shape or size. In FIG. 4B, slit 406 is shown over a radial line 408 of transmitter coil 102. Slit 406 may alternatively be over any other portion of transmitter coil 102. As shown in FIG. 4B, the portion of transmitter coil 102 physically covered by shield 112 is larger than the portion of transmitter coil 102 exposed by slit 406.

The configurations described in FIGS. 3, 4A, and 4B for transmitter coil 102 may be used in a similar manner for receiver coil 104. For example, receiver coil 104 may be on a PCB similar to PCB 302 and covered by a shield similar to shield 112.

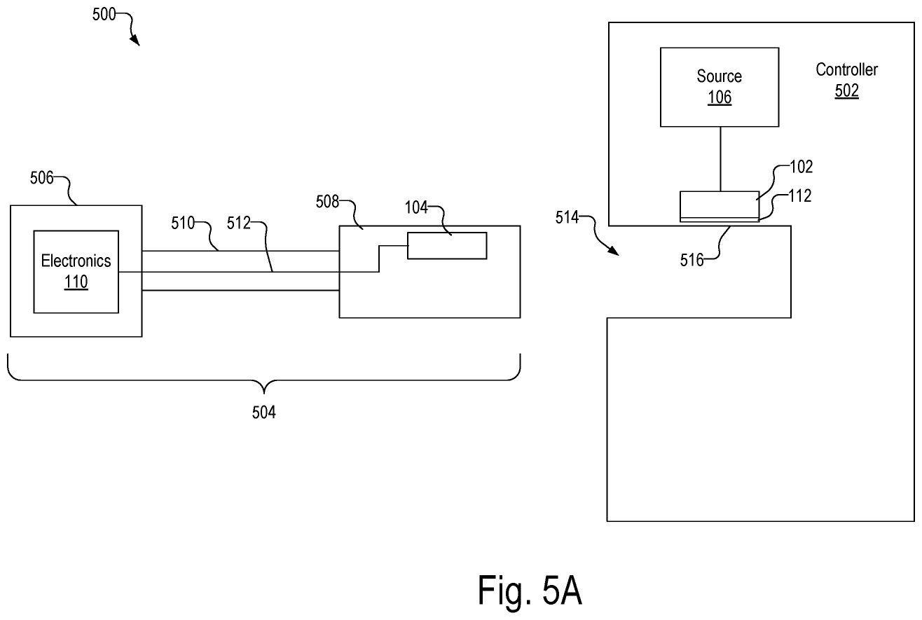

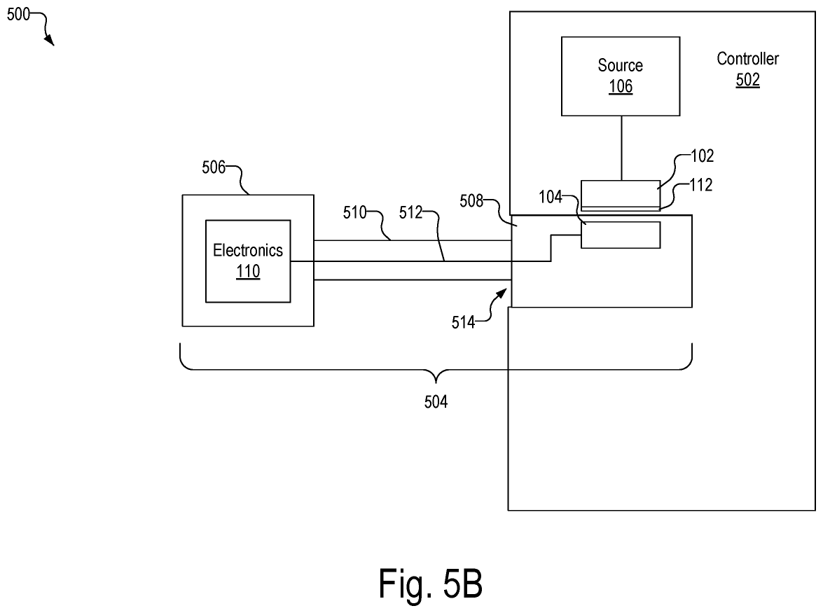

FIGS. 5A-5B show an exemplary implementation 500 of transmitting device 202 and receiving device 204. In implementation 500, transmitting device 202 is implemented by a controller 502, and receiving device 204 is implemented by an instrument 504.

Instrument 504 includes a housing 506, a contactless connector 508, and a cable 510 that physically connects contactless connector 508 to housing 506. Instrument 504 may be a surgical instrument (e.g., an imaging device such as an endoscope) configured to be controlled by a computer-assisted surgical system or any other computing device or system. Instrument 504 may alternatively be any other device or assembly.

Housing 506 includes electronics 110 and may be made out of any suitable material.

Contactless connector 508 includes receiver coil 104. Contactless connector 508 is “contactless” in the sense it does not include any external electrically conductive contacts (e.g., conductive pins, receptacles, pads, etc.) that conductively connect to corresponding contacts of a different device.

Cable 510 includes one or more wires (e.g., wire 512) that electrically connect receiver coil 104 to electronics 110. Cable 510 may have any suitable length.

Controller 502 may be implemented by any suitable computing device or system. For example, controller 502 may be implemented by a computing device in a computer-assisted surgical system. Controller 502 includes transmitter coil 102, shield 112, and source 106. Controller 502 further includes a receptacle 514. Transmitter coil 102 and shield 112 are behind a wall 516 of receptacle 514.

Receptacle 514 is positioned to receive contactless connector 508. For example, a user may insert contactless connector 508 into receptacle 514. FIG. 5B shows contactless connector 508 in receptacle 514. In this configuration, transmitter coil 102 is aligned with receiver coil 104, and shield 112 is between transmitter coil 102 and receiver coil 104.

Other implementations of transmitting device 202 and receiving device 204 may include configurations in which receiver coil 104 is brought into proximity with (e.g., placed on or over) transmitter coil 102 in any suitable manner.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A system comprising:
a transmitter coil configured to wirelessly transmit a signal to a receiver coil; and
an electrically conductive shield between the transmitter coil and the receiver coil and connected to an electrical ground, the electrically conductive shield being positioned to shunt electric field energy generated by the transmitter coil to the electrical ground and allow magnetic field energy to pass from the transmitter coil to the receiver coil.

2. The system of claim 1, wherein:
the system further comprises a printed circuit board comprising the electrical ground;
the transmitter coil is on the printed circuit board; and
the electrically conductive shield is connected to the electrical ground at a contact point on the printed circuit board.

3. The system of claim 2, wherein:
the electrically conductive shield is structurally connected to the printed circuit board at an additional contact point on the printed circuit board; and
the additional contact point not connected to the electrical ground.

4. The system of claim 2, wherein:
the system further comprises an electrically conductive connector that conductively connects the electrically conductive shield to the electrical ground at the contact point.

5. The system of claim 4, wherein:
the electrically conductive connector comprises at least one of a resistor, a wire, or electrically conductive tape.

6. The system of claim 1, wherein:
the electrically conductive shield physically covers at least a first portion of a top surface of the transmitter coil.

7. The system of claim 6, wherein:
the transmitter coil radially surrounds a center void; and
the electrically conductive shield does not physically cover the center void.

8. The system of claim 6, wherein:
the electrically conductive shield comprises a slit that exposes a second portion of the top surface of the transmitter coil; and
the slit is dimensioned to prevent eddy currents from being induced from the transmitter coil into the electrically conductive shield.

9. The system of claim 8, wherein:
the slit is positioned over a radial line of the transmitter coil.

10. The system of claim 1, wherein:
the electrically conductive shield is in physical contact with a top surface of the transmitter coil.

11. The system of claim 1, wherein:
the system further comprises a printed circuit board comprising the electrical ground;
the receiver coil is on the printed circuit board; and
the electrically conductive shield is connected to the electrical ground at a contact point on the printed circuit board.

12. The system of claim 1, wherein:
the electrically conductive shield is made out of an electrically conductive tape.

13. The system of claim 1, wherein:
the receiver coil is in a contactless connector coupled to electronics by way of a cable; and
the transmitter coil is in a controller for the electronics.

14. The system of claim 13, wherein the electronics are included in a surgical instrument.

15. The system of claim 1, wherein:
the signal comprises power for electronics electrically conductively coupled to the receiver coil.

16. The system of claim 1, wherein:
the system further comprises a source configured to generate the signal and provide the signal to the transmitter coil; and
the transmitter coil is connected to the source.

17. The system of claim 1, wherein:
the system further comprises a receptacle positioned to receive a contactless connector of an instrument, and the receptacle comprises a wall;
the receiver coil is in the contactless connector; and
the transmitter coil and the electrically conductive shield are behind the wall of the receptacle such that, while the contactless connector is in the receptacle, the transmitter coil is aligned with the receiver coil, and the electrically conductive shield is between the transmitter coil and the receiver coil.

18. An assembly comprising:
a printed circuit board comprising an electrical ground;
a transmitter coil on the printed circuit board and connected to the electrical ground, the transmitter coil comprising a top surface;
an electrically conductive shield connected to the electrical ground and that physically covers at least a first portion of the top surface of the transmitter coil; and
a receptacle positioned to receive a contactless connector of an instrument;
wherein the printed circuit board, the transmitter coil, and the electrically conductive shield are behind a wall of the receptacle such that, while the contactless connector is positioned in the receptacle, the transmitter coil is aligned with a receiver coil in the contactless connector, and the electrically conductive shield is between the transmitter coil and the receiver coil.

19. The assembly of claim 18, wherein:
the transmitter coil is positioned to wirelessly transmit power for electronics in the instrument to the receiver coil; and
the electrically conductive shield is positioned to shunt electric field energy generated by the transmitter coil to the electrical ground and allow magnetic field energy to pass from the transmitter coil to the receiver coil.

20. A system comprising:
a controller and an instrument;
wherein the controller comprises:
a printed circuit board comprising an electrical ground,
a transmitter coil on the printed circuit board and connected to the electrical ground,
an electrically conductive shield that physically covers at least a first portion of a top surface of the transmitter coil and that is connected to the electrical ground, and
a receptacle comprising a wall;
wherein the instrument comprises:
a contactless connector shaped to be inserted into the receptacle, and
a receiver coil in the contactless connector; and
wherein the transmitter coil and the electrically conductive shield are behind the wall of the receptacle such that, while the contactless connector is in the receptacle, the transmitter coil is aligned with the receiver coil, and the electrically conductive shield is between the transmitter coil and the receiver coil.
